(19) United States
(12) Patent Application Publication
(10) Pub. No.: US 2018/0006313 A1
(43) Pub. Date: Jan. 4, 2018

(54) CARBON SUPPORTED CATALYST COMPRISING A MODIFIER AND PROCESS FOR PREPARING THE CARBON SUPPORTED CATALYST

(71) Applicant: BASF SE, Ludwigshafen (DE)

(72) Inventor: Andreas HAAS, Mannheim (DE)

(21) Appl. No.: 15/538,457

(22) PCT Filed: Dec. 21, 2015
(86) PCT No.: PCT/EP2015/080752

§ 371 Date: Jun. 21, 2017

(30) Foreign Application Priority Data
Dec. 22, 2014 (EP) 14199646.2

(51) Int. Cl. H01M 4/92; H01M 4/88

(52) U.S. Cl. CPC H01M 4/926; H01M 4/921; H01M 4/8803; H01M 4/8825; H01M 4/8882

(57) ABSTRACT

The invention is related to a carbon supported catalyst comprising
a carbon-comprising support with a BET surface area in a range from 400 m²/g to 2000 m²/g,
a modifier comprising at least one mixed metal oxide, comprising niobium and titanium, and/or a mixture, comprising niobium oxide and titanium oxide,
a catalytically active metal compound, wherein the catalytically active metal compound is platinum or an alloy comprising platinum and a second metal or an intermetallic compound comprising platinum and a second metal, the second metal being selected from the group consisting of cobalt, nickel, chromium, copper, palladium, gold, ruthenium, scandium, yttrium, lanthanum, niobium, iron, vanadium and titanium.

The invention is further related to a process for preparing the carbon supported catalyst.

The invention relates to a carbon supported catalyst comprising a carbon-comprising support, a modifier and a catalytically active metal compound. The invention is further related to a process for preparation of the carbon supported catalyst.

Carbon supported catalysts are for example applied in proton exchange membrane fuel cells (PEMFC). PEMFCs are applied for an efficient conversion of stored chemical energy to electric energy. It is expected that future applications of PEMFCs are in particular mobile applications. For electrocatalysts, typically carbon supported platinum nanoparticles are used. These systems still require improvement concerning the activity and stability.

Under reaction conditions, which are predominant in PEMFCs, the catalyst underlies various deactivation mechanisms. Especially, the cathode of the PEMFC is affected. For example, platinum can be dissolved and re-deposited in different positions on the catalyst or on a membrane present in the PEMFC. Due to the deposition onto other platinum particles, the diameter of the particles increases. This sintering mechanism results in a reduced number of accessible metal atoms of the catalytically active platinum and therefore, in a reduced activity of the catalyst. As additional sintering mechanism, migration of platinum particles on the surface of the carbon-comprising support might occur, followed by agglomeration and loss of active surface area. This also results in a reduced activity of the catalyst.

It is known that deactivation of such electrocatalysts can be reduced by addition of a modifier as third component to the support and the platinum. Stabilizing effects were shown for metal oxides like TiO₂ and SnO₂ for example in B. R. Camacho, Catalysis today 220 (2013), pages 36 to 43.

According to an overview from K. Sasaki et al., ECS Trans. 33 (2010), pages 473 to 482, it is expected that among others Nb₂O_{5,} TiO₂ and SnO₂ are stable modifiers for the desired applications.

In US 2013/164655 A1, a catalyst is described, which comprises an alloy or an intermetallic composition of platinum and a second metal and an oxide of the second metal as well as a carbon-comprising support. As for the second metal, niobium, tantalum, vanadium and molybdenum are mentioned. According to X-ray diffraction measurements no crystalline constituents are comprised apart from a platinum or Pt₂Nb phase. Advantages of the catalyst described in US 2013/164655 A1 in comparison to a catalyst comprising only platinum and carbon are a high activity, referring to the comprised mass of platinum, for the oxygen reduction reaction as well as a high stability in a potential range between 0.1 V and 1 V. For a loading of the carbon-comprising support with niobium oxide, a sol-gel process is applied. Amorphous Nb₂O₅ is formed by a heat treatment of a catalyst precursor at 400° C. in an argon atmosphere. The catalyst precursor comprising niobium oxide is subsequently loaded with 30% by weight of platinum applying platinum(II)acetylacetonate as a platinum precursor compound. In an alternative procedure described in US 2013/164655 A1, a niobium oxide precursor and a platinum precursor are deposited simultaneously on the carbon-comprising support by means of a sol-gel process. In order to influence the hydrolysis rate, a strong acid is added.

For the deposition of niobium oxide onto carbon-comprising supports different methods are known. To be mentioned as an example is a loading of a substrate with a sol-gel process as described in Landau et al., in: “Handbook of Heterogeneous Catalysis” 2^{nd} Ed., G. Ertl, H. Knözinger, F. Schüth, J. Weitkamp (Eds.), 2009, pages 119 to 160. According to the international union of pure and applied chemistry, a sol-gel process is understood to be a process through which a network is formed from solution by a progressive change of liquid precursors into a sol, to a gel and in most cases, finally to a dry network.

In Landau et al., it is described that gel formation generally occurs by hydrolysis and condensation of corresponding hydrolysable metal compositions by water. Condensation in absence of water is only possible when two different metal compositions are present, as for example an alcoholate and an acetate as disclosed in Vioux et al., Chemistry of Materials 9 (1997), pages 2292 to 2299. In presence of only a metal alcoholate and an acid, but without any addition of water, no condensation of the metal composition is expected, but rather the formation of an ester from the alcoholate and the acid.

N. Özer et al., in Thin Solid Films 227 (1996), pages 162 to 168, describes that a time required for gel formation from niobium ethanolate is often several days, in presence of small amounts of acetic acid even 52 days. The aging is an important step in sol-gel processes as sol particles are cross-linked to polymeric structures.

WO 2011/038907 A2 describes a catalyst composition comprising an intermetallic phase comprising platinum and a metal selected from either niobium or tantalum, and a dioxide of the metal. For the production of the catalyst, the mixture of the metal, a platinum compound and a basic salt is prepared.

In US 2010/0068591 A1, a fuel cell catalyst is disclosed comprising an oxide of niobium (Nb₂O₅) and/or an oxide of tantalum (Ta₂O₅) supported on a conductive material. The catalyst is prepared by mixing a suspension of carbon supported platinum with niobium chloride and a reducing agent. The suspension was dried at 80° C. for six hours.

Lü et al., in Journal of the American Chemical Society 136 (2014), pages 419 to 426, describes an enhanced electron transport in Nb-doped TiO_{2.} A poor electrical conductivity of TiO₂ is addressed without studying interactions with carbon-comprising supports and/or catalytically active metal compounds such as platinum.

In Ignaszak et al., in Electrochimica Acta 78 (2012), pages 220 to 228, electro-catalysts containing palladium-platinum-alloys are discussed. Vulcan XC72 is loaded with a platinum-palladium alloy and a mixed metal oxide. A specific surface area of 176 m²/g was determined for the used carbon particles.

In order to further enhance the activity and stability of carbon supported catalysts, an optimization of the composition of the carbon supported catalyst, especially of the composition of the modifier, as well as an optimization of the process for the production of the carbon supported catalyst is required.

It is an object of the invention to provide a carbon supported catalyst with increased activity and/or stability.

It is a further object of the invention to provide a process for the preparation of the carbon supported catalyst, which provides a uniform distribution of the modifier on the carbon-comprising support leading to a high specific activity and stability. Due to the uniform distribution of the modifier on the carbon-comprising support, a large contact area between the modifier and the catalytically active metal compound should be provided. Further, the process should offer economic advantages in terms of high space-time yields due to low residence times. Further, the usage of only non-flammable gas in a heat treatment should be possible and an operation of the production process in a continuous mode should be easier to realize.

The object is achieved by a carbon supported catalyst comprising
a carbon-comprising support with a BET surface area in a range from 400 m²/g to 2000 m²/g,
a modifier comprising at least one mixed metal oxide, comprising niobium and titanium and/or a mixture, comprising niobium oxide and titanium oxide,
a catalytically active metal compound, wherein the catalytically active metal compound is platinum or an alloy comprising platinum and a second metal or an intermetallic compound comprising platinum and a second metal, the second metal being selected from the group consisting of cobalt, nickel, chromium, copper, palladium, gold, ruthenium, scandium, yttrium, lanthanum, niobium, iron, vanadium and titanium.

Many oxides like Nb₂O₅ are poor electrical conductors. When used as a modifier for electrocatalysts, the poor electrical conduction may result in a disadvantageous performance in membrane-electrode assemblies at high current densities. Insulating oxides applied as modifiers to catalysts can lead to a reduced activity of the catalytically active metal compound deposited on the insulating oxides. The poor electrical conduction of the niobium oxide is counteracted by addition of titanium oxide according to the invention. Oxides comprising niobium and titanium show a higher conductivity compared to mono-metallic oxides. Still, compared to niobium oxide modified catalysts, a similar stabilization of the catalytically active metal compound can be obtained.

Further, the object is achieved by a process for preparing the carbon supported catalyst comprising the following steps:
(a) precipitation of the modifier onto the surface of the carbon-comprising support by preparing an initial mixture, comprising the carbon-comprising support, at least two metal oxide precursors, a first precursor comprising niobium and a second precursor comprising titanium and a solvent, and drying of the initial mixture to obtain an intermediate product, or heating the initial mixture to a temperature at which the initial mixture is boiling, followed by filtration,
(b) loading of the catalytically active metal compound in form of particles onto the surface of the intermediate product in a liquid medium by deposition, precipitation and/or reduction of a catalytically active metal-comprising precursor with a reducing agent,
(c) heat treatment of the catalyst precursor resulting from step (b) at a temperature of at least 200° C.

For example for use as cathode catalyst in fuel cells, the catalytically active material is selected from among platinum and alloys and/or intermetallic compounds comprising platinum. Suitable second metals, comprised in the alloys and/or intermetallic compounds are, for example, nickel, cobalt, iron, vanadium, titanium, ruthenium, chromium, scandium, yttrium, palladium, gold, lanthanum, niobium and copper, in particular nickel, cobalt and copper. Suitable alloys and/or intermetallic compounds comprising platinum are, for example, selected from the group consisting of PtNi, PtFe, PtV, PtCr, PtTi, PtCu, PtPd and PtRu. Particular preference is given to a platinum-nickel alloy and/or intermetallic compound, a platinum-copper alloy and/or intermetallic compound or a platinum-cobalt alloy and/or intermetallic compound, or a ternary alloy and/or intermetallic compound comprising PtNi, PtCo or PtCu. When an alloy and/or intermetallic compound is used as catalytically active metal compound, the proportion of platinum in the alloy and/or intermetallic compound is preferably in the range from 25 to 95 atom % and preferably in the range from 40 to 90 atom %, more preferably in the range from 50 to 80 atom % and in particular in the range from 60 to 80 atom %.

Apart from the alloys and/or intermetallic compounds mentioned, it is also possible to use alloys and/or intermetallic compounds which comprise more than two different metals, for example ternary alloy systems.

Catalytically active metal compound is understood to be a compound which catalyzes the electrochemical oxygen reduction reaction, typically in a medium with a pH-value of less than 7. Preferably, the catalytically active metal compound consists of platinum. Preferably, at least part of the catalytically active metal compound is present in form of particles with a diameter of not more than 100 μm in the carbon supported catalyst, more preferably in form of nanoparticles with a diameter of not more than 1000 nm.

Preferably, at least 90% by number of platinum-comprising particles as catalytically active metal compound comprised in the carbon support catalyst have a diameter smaller than 20 nm, more preferably smaller than 10 nm and in particular preferably smaller than 6 nm. The particles are typically not smaller than 1 nm.

The carbon supported catalyst preferably comprises 10% to 50% by weight of platinum, more preferred 15% to 40% by weight and most preferred 20% to 35% by weight.

Nb-doped titanium dioxide is preferred as modifier. The titanium dioxide is preferably present as anatase. Preferably, the modifier consists of niobium, titanium and oxygen. In this embodiment, no other metals than niobium and titanium are comprised in the modifier. More preferably, all metals comprised in the carbon supported catalyst are comprised in the modifier and in the catalytically active metal compound. Particularly preferred, all metals comprised in the carbon supported catalyst are platinum, niobium and titanium. In this embodiment, no other metals than platinum, niobium and titanium are comprised in the carbon supported catalyst.

The carbon supported catalyst preferably comprises 0.5% to 20% by weight of niobium, more preferred 0.6% to 10% by weight and most preferred 0.8% to 5% by weight. The carbon supported catalyst further comprises preferably 0.5% to 20% by weight of titanium, more preferred 0.9% to 10% by weight and most preferred 3% to 8% by weight.

Preferably, the ratio of the molar amount of niobium comprised in the carbon supported catalyst to the sum of the molar amount of niobium and the molar amount of titanium, comprised in the carbon supported catalyst, is in a range from 0.01 to 0.5, more preferred from 0.02 to 0.2 and most preferred from 0.03 to 0.15.

In one embodiment, the carbon-comprising support comprises carbon black, graphene, graphite, activated carbon or carbon nanotubes. More preferably, the carbon-comprising support comprises more than 90% by weight of carbon black.

According to the invention the BET surface area of the carbon-comprising support is in the range from 400 m²/g to 2000 m²/g. Preferably, the BET surface area of the carbon-comprising support is in a range from 600 m²/g to 2000 m²/g, more preferred in a range from 1000 m²/g to 1500 m²/g. With a higher surface area of the carbon-comprising support, higher activities of the carbon supported catalyst can be obtained. The BET surface can be measured according to DIN ISO 9277:2014-01. For example, the carbon-comprising support Black Pearls® 2000 possesses a surface area of approximately 1389 m²/g.

The carbon-comprising support has to provide stability, conductivity and a high specific surface area. Conductive carbon blacks are particularly preferably used as carbon-comprising supports. Carbon blacks which are normally used are, for example, furnace black, flame black or acetylene black. Particularly preferred are furnace blacks, for example available as Black Pearls® 2000.

The invention is further related to an electrode comprising the carbon supported catalyst and to a fuel cell comprising the electrode.

In the first step (a) of the inventive process for preparing the carbon supported catalyst the surface of the carbon-comprising support is loaded with the modifier. The initial mixture to be dried comprises the carbon-comprising support, the at least two metal oxide precursors, which are converted into the at least one mixed metal oxide and/or the mixture comprising niobium oxide and titanium oxide, and the solvent. The solid matter obtained from drying is further processed as intermediate product, which is the carbon-comprising support loaded with the modifier. In the context of the present invention, drying is understood to include the removal of water as well as the removal of organic solvents from the solid matter.

Preferably, the at least two metal oxide precursors are an alcoholate or a halide, respectively. Preferred alcoholates are ethanolates, n-propanolates, iso-propanolates, n-butanolates, iso-butanolates and tert-butanolates, particularly preferred are niobium(V)ethoxide and titanium(IV)n-butoxide, respectively. Chloride is a preferred halide. Apart from the comprised metal, which is either niobium or titanium, respectively, the at least two metal oxide precursors can have the same composition or different compositions.

The solvent comprises preferably an alcohol, a carboxylate ester, acetone or tetrahydrofuran. 2-propanol is a preferred alcohol as solvent in the initial mixture. Most preferably, the solvent comprises at least 98% by volume of 2-propanol.

In a preferred embodiment, the initial mixture comprises less than 2%, preferably less than 1%, particularly preferably less than 0.5% and most preferably less than 0.2% by weight of water. In this embodiment, the small amounts of residual water present in the initial mixture are introduced into the initial mixture as part of at least one of the components present in the initial mixture as for example the solvent or the carbon-comprising support, which are commercially available at limited purities and which can comprise small percentages of water. A commercially available carbon-comprising support may comprise for example up to 5%, generally up to 2% and preferably up to 1% by weight of water, depending on storage conditions. In this embodiment, no additional water is added to the initial mixture or to the components added to the initial mixture.

In an alternatively preferred embodiment, the initial mixture comprises up to 20% by weight of water, preferably between 2% and 10% of water and particularly preferably between 3% and 8% by weight of water. In this alternative embodiment water is an independent and additionally added constituent of the initial mixture.

Preferably, the initial mixture comprises an acid. The acid is preferably a carboxylic acid. Preferably the pKa value of the acid is 3 or higher. In a particularly preferred embodiment, the acid is acetic acid. The presence of the acid in the initial mixture stabilizes the modifier precursor in solution and an undesired solid or gel formation in the initial mixture prior to the drying is avoided.

The initial mixture usually has a carbon content in a range from 1% to 30% by weight, preferably from 2% to 6% by weight.

Preferably, a molar ratio of the sum of niobium and titanium comprised in the modifier precursor to carbon comprised in the carbon-comprising support in the initial mixture is from 0.005 to 0.13, preferably from 0.01 to 0.1.

The drying step in step (a) is preferably carried out by spray-drying.

By spray-drying the initial mixture a very homogeneous, fine and uniform distribution of the modifier over the surface of the carbon-comprising support is achieved. In case of a homogeneous distribution of the modifier a large interface between the modifier and the catalytically active metal compound comprising particles is achieved, which leads to an intimate contact, which in turn is crucial for an effective stabilization of the catalytically active metal compound, loaded onto the surface of the intermediate product, against dissolution. The produced carbon supported catalyst shows an increased stability against electrochemical dissolution. Therefore, a re-deposition of the dissolved catalytically active metal compound onto other catalytically active metal compound comprising particles on the surface of the carbon supported catalyst is reduced. This re-deposition would lead to an increased size of the loaded catalytically active metal compound comprising particles. An increased size of the particles is disadvantageous as the specific activity referring to the mass of catalytically active metal compound is reduced. Simultaneously, short residence times and high space-time yields can be realized when spray-drying is applied.

Preferably, the drying is carried out with an inert drying gas and a drying gas temperature from 60° C. to 300° C., particularly preferably from 100° C. to 260° C. and most preferably from 150 to 220° C. An inert drying gas is understood as a gas, which shows a low reactivity towards the components of the initial mixture. The drying gas temperature is preferably selected in a way that a residue in components, which are evaporated under air at a temperature of 180° C., is present with a content of less than 30% by weight in the solid after drying. An exhaust gas of the dryer, which is preferably the spray-dryer, has a temperature in a range of preferably 50° C. to 160° C., particularly preferably from 80° C. to 120° C., most preferably from 90° C. to 110° C.

Preferably, the spray-drying is carried out by means of a two-fluid nozzle, a pressure nozzle or a centrifugal atomizer. A diameter of the nozzle of a spray-dryer with a two-fluid nozzle is preferably between 1 mm and 10 mm, particularly preferably between 1.5 mm and 5 mm and most preferably between 2 mm and 3 mm. For a two-fluid nozzle, a nozzle pressure is preferably between 1.5 bar and 10 bar absolute, particularly preferably between 2 bar and 5 bar absolute and most preferably between 3 bar and 4 bar absolute.

In a further preferred embodiment, the spray-drying is carried out in a countercurrent mode with the advantage to reduce the working volume.

In a further preferred embodiment, the spray-drying is operated with a residence time referring to solid matter in a drying zone of the spray-dryer of less than 3 minutes, preferably of less than 2 minutes and particularly preferably of less than 1 minute. In laboratory scale, in which the distance between the nozzle of the spray dryer and the apparatus for separation of the solid matter is typically not more than 1 m, the residence time is preferably shorter than 1 minute and particularly preferably less than 30 seconds. In industrial scale, the residence time is preferably shorter than 2 minutes and particularly preferred shorter than 1 minute. A short residence time offers the advantage of a high space-time yield for the process and therefore an effective production. Due to the comparably short residence times no substantial gel formation is expected. Further, a fast removal of the liquid constituents of the initial mixture supports the fine and uniform distribution of the modifier on the surface of the carbon-comprising support. In contrast, a slow removal of the liquid constituents of the initial mixture, which takes several hours, leads to a more heterogeneous distribution of the modifier on the surface of the carbon-comprising support. This might be due to a heterogeneous concentration distribution of reactants during a slow evaporation of solvents and locally increased concentrations of the modifier precursor in the area of the gas/liquid interface.

Preferably, solid matter, which is the intermediate product, is separated after drying by means of a cyclone. In industrial scale, a filter can be applied for this purpose, whereby the filter can be heated to constant temperatures in order to prevent condensation.

In an alternative embodiment the intermediate product is achieved by heating the initial mixture to a temperature at which the initial mixture is boiling, followed by filtration and washing with a washing liquid comprising a solvent. For heating the initial mixture any heater known to a skilled person can be used. Preferred are heaters which operate indirectly with a heating medium, for example a thermal oil or steam. Generally the initial mixture is heated to a temperature in the range from 68 to 150° C., preferably in the range from 80 to 120° C., for 20 min to 24 h, preferably 30 min to 8 h.

After heating, the mixture preferably is cooled down to room temperature and then filtered and washed. For the filtration step, any filter can be used which is suitable for removing the solid intermediate product from the mixture.

To remove remainders of the liquid components, in a preferred embodiment the filtered intermediate product is washed with a washing liquid comprising a solvent. The solvent thereby preferably corresponds to the solvent used in the initial mixture. If the initial mixture additionally comprises an acid, particularly a carboxylic acid, the washing liquid preferably is a mixture comprising the solvent and an acid. The acid preferably is the same acid as the acid in the initial mixture.

The intermediate product obtained in step (a) can be grounded in order to provide solid particles with a mean diameter between 0.1 μm and 10 μm. The particles of the intermediate product, which are loaded with catalytically active metal compound, possess preferably a mean diameter between 0.1 μm and 5 μm.

In an embodiment, after drying in step (a) or after washing with the washing liquid, the intermediate product is washed with water and dried before the loading of the catalytically active metal compound in step (b) in order to remove solvent and/or acid residues, which might interfere with the loading process of the catalytically active metal compound. Even though a washing step is not mandatory for a stable and active resulting carbon supported catalyst, washing can be advantageous for a homogeneous distribution of the catalytically active metal compound and for a small particle size of the catalytically active metal compound.

In the subsequent step (b) the surface of the intermediate product, which is already loaded with the modifier, is further loaded with the catalytically active metal compound.

Application of the catalytically active metal compound onto the surface of a support or on the intermediate product can be effected by any method known to those skilled in the art. Thus, for example, the catalytically active metal compound can be applied by deposition from solution. For this purpose, it is possible, for example, to dissolve the catalytically active metal compound in a solvent. The metal can be bound covalently, ionically or by complexation. Furthermore, it is also possible for the metal to be deposited reductively, as precursor or by precipitation of the corresponding hydroxide. Further possibilities for depositing the catalytically active metal compound are impregnation using a solution comprising the catalytically active metal compound (incipient wetness), chemical vapor deposition (CVD) or physical vapor deposition (PVD) and all further processes known to those skilled in the art by means of which the catalytically active metal compound can be deposited. As platinum is comprised in the catalytically active metal compound, preference is given to reductively precipitating a salt of the metal.

In a preferred embodiment, for the loading of the catalytically active metal compound on the surface of the intermediate product, the catalytically active-metal-comprising precursor, which is preferably platinum(II)hydroxide or platinum(IV)hydroxide, is deposited onto the surface of the intermediate product in the liquid medium, a reducing agent is added to the liquid medium and the catalytically active-metal-comprising precursor is reduced.

The reducing agent can be chosen from various compounds as for example alcohols, such as ethanol or 2-propanol, formic acid, sodium formiate, ammonium formiate, ascorbic acid, glucose, ethylene glycol or citric acid. Preferably, the reducing agent is an alcohol, particularly ethanol. By the precipitation of the catalytically active-metal-comprising precursor with a reducing agent a homogeneous distribution of the catalytically active metal compound over the surface of the carbon-comprising support is achieved as the deposition is not selectively directed to the modifier, already present on the surface of the carbon-comprising support.

In a further alternative preferred embodiment, the catalytically active metal compound is loaded directly onto the surface of the intermediate product by any method known by a person skilled in the art. An example for the loading of the catalytically active metal compound onto the surface of the intermediate product is also the impregnation of the intermediate product with platinum(II)acetylacetonate, which is reduced by the heat treatment under a reducing atmosphere.

When the catalytically active metal compound is applied by precipitation, it is possible to use, for example, a reductive precipitation, for example of platinum from platinum nitrate by ethanol, by means of NH₄OOCH or NaBH₄. As an alternative, decomposition and reduction in H₂/N₂, for example of platinum acetylacetonate mixed with the intermediate product, is also possible. Very particular preference is given to reductive precipitation by means of ethanol. In a further embodiment, the reductive precipitation is effected by means of formic acid.

Preferably, a molar ratio of the sum of niobium and titanium, originating from the modifier precursor and comprised in the intermediate product, to the platinum comprised in the liquid medium is between 0.05 and 2.0, preferably between 0.2 and 1.5.

In one embodiment, the liquid medium, in which the catalytically active metal compound is loaded onto the surface of the surface of the intermediate product, comprises water. A water content in the liquid medium is preferably higher than 50% by weight, particularly preferably higher than 70% by weight. However, it is alternatively possible that the liquid medium is free of water.

Once the surface of the carbon-comprising support is loaded with the modifier and the catalytically active metal compound, resulting in the catalyst precursor, the catalyst precursor is heat-treated at a temperature of at least 200° C. in a third step (c). The heat treatment in step (c) primarily affects the modifier and thereby further stabilizes the interaction between the modifier and the catalytically active metal compound, leading to a more stable catalytically active metal compound towards electrochemical dissolution and/or sintering.

Preferably, the catalyst precursor is dried at a temperature lower than 200° C. before being heat-treated.

The heat treatment is preferably carried out at temperatures of at least 400° C. Temperatures of at least 550° C. are more preferred and temperatures of at least 600° C. are particularly preferred. Temperatures between 780° C. and 820° C. are most preferred.

Preferably, the heat treatment in step (c) is carried out in a reducing atmosphere, which more preferably comprises hydrogen. Preferably less than 30% by weight and particularly preferably less than 20% by weight of hydrogen are comprised in the reducing atmosphere. In a particularly preferred embodiment, the reducing atmosphere comprises only up to 5% by volume of hydrogen. For these low hydrogen concentrations, the reducing atmosphere is a non-flammable gas mixture and investment costs for the plant construction and costs for plant operation can be reduced. In presence of an inert gas without a reducing component during the heat treatment in step (c) a drying process is predominant over the reductive process. In presence of oxygen a passivation of the catalytically active metal compound occurs, which is typically effectuated after the heat treatment.

The heat treatment can be carried out in a furnace. A suitable furnace is, for example, a rotary bulb furnace. A rotary tube furnace can also be used, either in batch operation or in continuous operation. Apart from the use of the furnace, the use of a plasma or the use of a microwave operation is also possible for heating.

A use of a continuously operable furnace in combination with spray-drying in one process offers the possibility to design a continuous process for the production of the carbon supported catalyst.

The carbon supported catalyst can be used, for example, to produce electrodes which are used in electrochemical cells, for example batteries, fuel cells or electrolysis cells. The catalysts can be used both on the anode side and on the cathode side. Particularly on the cathode side, it is necessary to use active cathode catalysts which are also stable against degradation, with the stability being determined both by the stability of the support itself and by the stability of the catalytically active metal compound against dissolution, particle growth and particle migration, which is influenced by the interaction of the catalytically active metal compound with the support surface. A specific example is the use of the electrodes in fuel cells, for example proton-exchange membrane fuel cells (PEMFCs), direct methanol fuel cells (DMFCs), direct ethanol fuel cells (DEFCs), etc. Fields of application of such fuel cells are local energy generation, for example for household fuel cell systems, and also mobile applications, for example in motor vehicles. Particular preference is given to use the in PEMFCs.

Further catalytic applications for the carbon supported catalyst are as cathode catalysts (both for the oxygen evolution reaction (OER) and, preferably, for the oxygen reduction reaction (ORR)) in metal air batteries, etc.

### EXAMPLES AND COMPARATIVE EXAMPLES

### I. Preparation of carbon supported catalysts

### EXAMPLES

Inventive catalysts with three different degrees of niobium doping in titanium oxide were prepared. The ratio of the molar amount of niobium comprised in the carbon supported catalyst to the sum of the molar amount of niobium and the molar amount of titanium comprised in the carbon supported catalyst (n_{Nb}/(n_{Nb}+n_{Ti})) was namely 0.08, 0.05 and 0.46, respectively for examples 1 to 3.

### Example 1

### 1a) Precipitation of Mixed Niobium Titanium Oxide onto Carbon

A mixture was prepared from 60 g carbon (Black Pearls® 2000, Cabot), 455 g acetic acid with a purity of 100%, 676 g 2-propanol with a purity of 99.7%, 10.4 g niobium(V)ethoxide with a purity of 99.95%, based on the metal content, and 100 g titanium(IV)n-butoxide with a purity of 99%. In order to homogenize the components, ultra-sonication was for applied for 10 minutes. The mixture was dried in a spray-dryer. In order to prevent sedimentation, the mixture was agitated while being conveyed into the spray-tower. The flow rate of the mixture to be spray-dried was 636 g/h, the diameter of the nozzle of the spray-dryer was 1.4 mm, the nozzle pressure was 3,5 bar absolute, the nozzle gas was nitrogen, the volume flow of the nozzle gas was 3.5 Nm³/h, the temperature of the nozzle gas was room temperature, the drying gas was nitrogen, the volume flow of the drying gas was 25 Nm³/h, the temperature of the drying gas was 190° C. and the residence time in the spray-dryer was 15 seconds. For particle separation, a cyclone was applied, which is able to separate particles with a diameter of at least 10 μm. The temperature in the cyclone, corresponding to the exhaust gas temperature of the spray-dryer, was 102° C. to 104° C. All above-described production steps were carried out with exclusion of humidity. No extra water was added in any of the above-described production steps and the mixture to be spray-dried was prepared under nitrogen atmosphere.

An elementary analysis showed a niobium content of 1.3% by weight and a titanium content of 6.5% by weight, referring to the spray-dried particles. During drying in an air stream at 180° C. for analytic purposes, a mass loss of 28.7% by weight was determined.

### 1b) Washing

Residue organic compounds were removed by washing. 71 g of the solid obtained in step 1a) was put on a filter and water was added. A total volume of 7 L of water was used for the washing. Subsequently, the washed solid was dried in a vacuum oven at 80° C. for 10 hours.

An elementary analysis showed a niobium content of 1.7% by weight and a titanium content of 7.7% by weight, referring to the washed and dried solid. During drying in an air stream at 180° C. for analytic purposes, a mass loss of 12.2% by weight was determined.

### 1c) Deposition of Platinum

For the deposition of platinum, 15 g of the solid obtained in step 1 b) were suspended in 412 mL water by means of an ULTRA-TURRAX®. Then, a solution of 10.95 g platinum(II)nitrate in 161 mL water was added. Under stirring, a mixture of 354 mL ethanol and 487 mL water was added and the suspension was heated to 82° C. After six hours at 82° C., the suspension was cooled to room temperature, filtered and the solid residue was washed with 6 L water. The resulting solid was dried in a vacuum oven at 80° C.

### 1d) Heat Treatment at 800° C.

12 g of the solid resulting from step 1c) were heat treated in a rotary tube furnace. In a stream comprising 95% by volume of nitrogen and 5% by volume of hydrogen, the temperature was raised by 10 Kelvin per minute to 800° C. When the temperature of 800° C. was reached, the temperature was kept constant for one hour. Subsequently, the interior of the furnace was cooled to room temperature and at a temperature below 50° C., the gas stream was switched to a stream comprising 100% by volume nitrogen. Then, the heat treated solid was passivated for 12 hours with a gas stream comprising 9% by volume air and 91% by volume nitrogen to form the carbon supported catalyst. Air typically comprises approximately 78% by volume nitrogen and 21% by volume oxygen.

By elementary analysis, a niobium content of 1.0% by weight, a titanium content of 5.8% by weight and a platinum content of 33% by weight, referring to the carbon supported catalyst, was determined.

The carbon supported catalyst was further analyzed by powder X-ray diffractometry. The average crystallite size of the platinum comprised in the carbon supported catalyst was calculated from the powder X-ray diffractometry results applying the Scherrer formula. A bimodal distribution of 3.2 nm and 32 nm was determined for the platinum crystallite. This integral method, combined with TEM results, indicated that most of the platinum particles were of a small size of approximately 3 nm and, in addition, a group of larger platinum particles with an average crystallite size of approximately 32 nm was present. Further, a crystallographic phase of TiO₂ (anatase) was observed in the carbon supported catalyst by powder X-ray diffractometry.

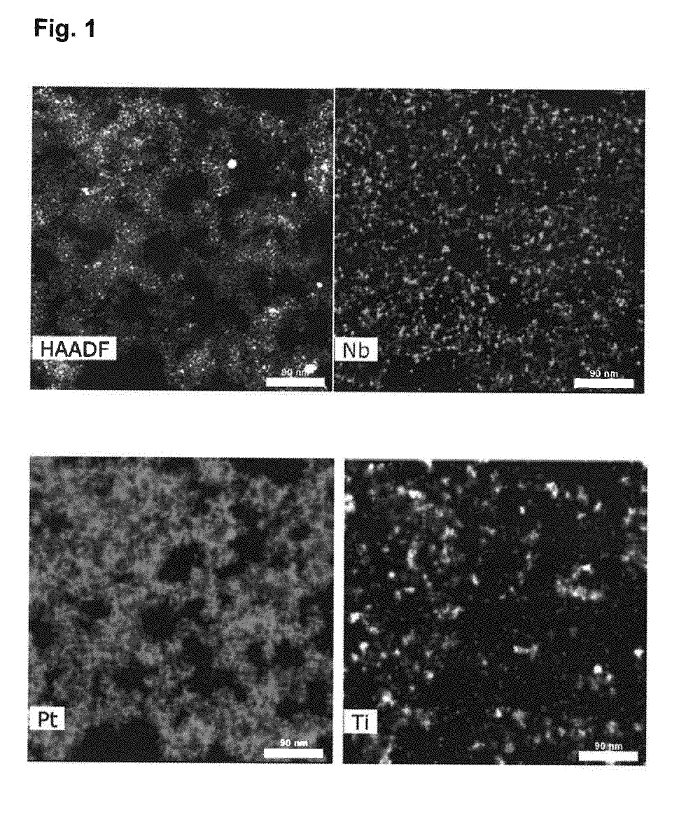

FIG. 1 shows pictures obtained by transmission electron microscopy (TEM) of the carbon supported catalyst produced in example 1. The transmission electron microscopy was coupled with energy-dispersive X-ray spectroscopy (EDX) analysis. A first image (high angle annular dark field, HAADF), provides an overview of the distribution of material density, referring to the electron density, in the sample. Platinum shows the highest contrast, grey areas are assigned to carbon and oxides of niobium and titanium. In three further images, the distribution of the single elements niobium, platinum and titanium are represented separately. For all images the given comparative scale is 90 nm. The elements platinum, niobium and titanium were homogeneously dispersed on the surface of the carbon supported catalyst.

### Example 2

### 2a) Precipitation of Mixed Niobium Titanium Oxide onto Carbon

A mixture was prepared from 60 g carbon (Black Pearls® 2000, Cabot), 455 g acetic acid with a purity of 100%, 676 g 2-propanol with a purity of 99.7%, 4.92 g niobium(V)ethoxide with a purity of 99.95%, based on the metal content, and 100 g titanium(IV)n-butoxide with a purity of 99%. In order to homogenize the components, ultra-sonication was for applied for 10 minutes. The mixture was dried in a spray-dryer. In order to prevent sedimentation, the mixture was agitated while being conveyed into the spray-tower. The flow rate of the mixture to be spray-dried was 743 g/h, the diameter of the nozzle of the spray-dryer was 1.4 mm, the nozzle pressure was 3.5 bar absolute, the nozzle gas was nitrogen, the volume flow of the nozzle gas was 3.5 Nm³/h, the temperature of the nozzle gas was room temperature, the drying gas was nitrogen, the volume flow of the drying gas was 25 Nm³/h, the temperature of the drying gas was 190° C. and the residence time in the spray-dryer was 15 seconds. For particle separation, a cyclone was applied, which is able to separate particles with a diameter of at least 10 μm. The temperature in the cyclone, corresponding to the exhaust gas temperature of the spray-dryer, was 101° C. to 104° C. All above-described production steps were carried out with exclusion of humidity. No extra water was added in any of the above-described production steps and the mixture to be spray-dried was prepared under nitrogen atmosphere.

An elementary analysis showed a niobium content of 0.6% by weight and a titanium content of 5.6% by weight, referring to the spray-dried particles. During drying in an air stream at 180° C. for analytic purposes, a mass loss of 31% by weight was determined.

### 2b) Washing

Residue organic compounds were removed by washing. 71 g of the solid obtained in step 2a) was put on a filter and water was added. A total volume of 7 L of water was used for the washing. Subsequently, the washed solid was dried in a vacuum oven at 80° C. for 10 hours.

An elementary analysis showed a niobium content of 0.9% by weight and a titanium content of 8.6% by weight, referring to the washed and dried solid. During drying in an air stream at 180° C. for analytic purposes, a mass loss of 4.1% by weight was determined.

### 2c) Deposition of Platinum

For the deposition of platinum, 15 g of the solid obtained in step 2b) were suspended in 414 mL water by means of an ULTRA-TURRAX®. Then, a solution of 10.95 g platinum(II)nitrate in 159 mL water was added. Under stirring, a mixture of 354 mL ethanol and 487 mL water was added and the suspension was heated to 82° C. After six hours at 82° C., the suspension was cooled to room temperature, filtered and the solid residue was washed with 6 L water. The resulting solid was dried in a vacuum oven at 80° C.

### 2d) Heat Treatment at 800° C.

15 g of the solid resulting from step 2c) were heat treated in a rotary tube furnace. In a stream comprising 95% by volume of nitrogen and 5% by volume of hydrogen, the temperature was raised by 10 Kelvin per minute to 800° C. When the temperature of 800° C. was reached, the temperature was kept constant for one hour. Subsequently, the interior of the furnace was cooled to room temperature and at a temperature below 50° C., the gas stream was switched to a stream comprising 100% by volume nitrogen. Then, the heat treated solid was passivated for 12 hours with a gas stream comprising 9% by volume air and 91% by volume nitrogen to form the carbon supported catalyst.

By elementary analysis, a niobium content of 0.58% by weight, a titanium content of 6.2% by weight and a platinum content of 30% by weight, referring to the carbon supported catalyst, was determined.

The carbon supported catalyst was further analyzed by powder X-ray diffractometry. The average crystallite size of the platinum comprised in the carbon supported catalyst was calculated from the powder X-ray diffractometry results applying the Scherrer formula. A bimodal distribution of 3.2 nm and 32 nm was determined for the platinum crystallite size. Further, a crystallographic phase of TiO₂ (anatase) was observed in the carbon supported catalyst by powder X-ray diffractometry.

### Example 3

### 3a) Precipitation of Mixed Niobium Titanium Oxide onto Carbon

A mixture was prepared from 60 g carbon (Black Pearls® 2000, Cabot), 455 g acetic acid with a purity of 100%, 676 g 2-propanol with a purity of 99.7%, 43.49 g niobium(V)ethoxide with a purity of 99.95%, based on the metal content, and 46.51 g titanium(IV)n-butoxide with a purity of 99%. In order to homogenize the components, ultra-sonication was for applied for 10 minutes. The mixture was dried in a spray-dryer. In order to prevent sedimentation, the mixture was agitated while being conveyed into the spray-tower. The flow rate of the mixture to be spray-dried was 516 g/h, the diameter of the nozzle of the spray-dryer was 1.4 mm, the nozzle pressure was 3.5 bar absolute, the nozzle gas was nitrogen, the volume flow of the nozzle gas was 3.5 Nm³/h, the temperature of the nozzle gas was room temperature, the drying gas was nitrogen, the volume flow of the drying gas was 25 Nm³/h, the temperature of the drying gas was 190° C. and the residence time in the spray-dryer was 15 seconds. For particle separation, a cyclone was applied, which is able to separate particles with a diameter of at least 10 μm. The temperature in the cyclone, corresponding to the exhaust gas temperature of the spray-dryer, was 100° C. to 107° C. All above-described production steps were carried out with exclusion of humidity. No extra water was added in any of the above-described production steps and the mixture to be spray-dried was prepared under nitrogen atmosphere.

An elementary analysis showed a niobium content of 5.3% by weight and a titanium content of 2.8% by weight, referring to the spray-dried particles. During drying in an air stream at 180° C. for analytic purposes, a mass loss of 26% by weight was determined.

### 3b) Washing

Residue organic compounds were removed by washing. 71 g of the solid obtained in step 3a) was put on a filter and water was added. A total volume of 7 L of water was used for the washing. Subsequently, the washed solid was dried in a vacuum oven at 80° C. for 10 hours.

An elementary analysis showed a niobium content of 6.4% by weight and a titanium content of 3.9% by weight, referring to the washed and dried solid. During drying in an air stream at 180° C. for analytic purposes, a mass loss of 14.3% by weight was determined.

### 3c) Deposition of Platinum

For the deposition of platinum, 15 g of the solid obtained in step 3b) were suspended in 414 mL water by means of an ULTRA-TURRAX®. Then, a solution of 10.95 g platinum(II)nitrate in 159 mL water was added. Under stirring, a mixture of 354 mL ethanol and 487 mL water was added and the suspension was heated to 82° C. After six hours at 82° C., the suspension was cooled to room temperature, filtered and the solid residue was washed with 6 L water. The resulting solid was dried in a vacuum oven at 80° C.

### 3d) Heat Treatment at 800° C.

15 g of the solid resulting from step 3c) were heat treated in a rotary tube furnace. In a stream comprising 95% by volume of nitrogen and 5% by volume of hydrogen, the temperature was raised by 10 Kelvin per minute to 800° C. When the temperature of 800° C. was reached, the temperature was kept constant for one hour. Subsequently, the interior of the furnace was cooled to room temperature and at a temperature below 50° C., the gas stream was switched to a stream comprising 100% by volume nitrogen. Then, the heat treated solid was passivated for 12 hours with a gas stream comprising 9% by volume air and 91% by volume nitrogen to form the carbon supported catalyst.

By elementary analysis, a niobium content of 4.7% by weight, a titanium content of 2.9% by weight and a platinum content of 34% by weight, referring to the carbon supported catalyst, was determined.

The carbon supported catalyst was further analyzed by powder X-ray diffractometry. The average crystallite size of the platinum comprised in the carbon supported catalyst was calculated from the powder X-ray diffractometry results applying the Scherrer formula. A bimodal distribution of 2.9 nm and 27 nm was determined for the platinum crystallite size. Further, a crystallographic phase of TiO₂ (anatase) was observed in the carbon supported catalyst by powder X-ray diffractometry.

### Example 4

### 4a) Reactive Deposition of Mixed Niobium Titanium Oxide onto Carbon

A mixture was prepared from 15 g carbon (Black Pearls® 2000, Cabot), 114 g acetic acid with a purity of 100%, 169 g 2-propanol with a purity of 99.7%, 2.61 g niobium(V)ethoxide with a purity of 99.95%, based on the metal content, and 24.99 g titanium(IV)n-butoxide with a purity of 99%. This mixture was transferred to a flask equipped with a magnetic stirrer, an oil bath and a water-cooled condenser. After purging with nitrogen, the mixture was heated under reflux at 94° C. for 1 h. The mixture was cooled to room temperature, filtrated and washed with a mixture of 570 g acetic acid with a purity of 100%, 845 g 2-propanol with a purity of 99.7%. Subsequently, the powder was washed with water of 60° C. until the filtrate's pH reached a value of 7. The washed solid was dried in a vacuum oven at 80° C. for 10 hours.

An elementary analysis of the dried solid showed a niobium content of 1.4% by weight and a titanium content of 6.8% by weight. During drying in an air stream at 180° C. for analytic purposes, a mass loss of 1.1% by weight was determined.

### 4b) Deposition of Platinum

For the deposition of platinum, 10 g of the solid obtained in step 4a) were suspended in 276 mL water by means of an ULTRA-TURRAX®. Then, a solution of 7.30 g platinum(II)nitrate in 106 mL water was added. Under stirring, a mixture of 236 mL ethanol and 326 mL water was added and the suspension was heated to 82° C. After six hours at 82° C., the suspension was cooled to room temperature, filtered and the solid residue was washed with 6 L water. The resulting solid was dried in a vacuum oven at 80° C.

### 4c) Heat Treatment at 800° C.

15 g of the solid resulting from step 3c) were heat treated in a rotary tube furnace. In a stream comprising 95% by volume of nitrogen and 5% by volume of hydrogen, the temperature was raised by 10 Kelvin per minute to 800° C. When the temperature of 800° C. was reached, the temperature was kept constant for one hour. Subsequently, the interior of the furnace was cooled to room temperature and at a temperature below 50° C., the gas stream was switched to a stream comprising 100% by volume nitrogen. Then, the heat treated solid was passivated for 12 hours with a gas stream comprising 9% by volume air and 91% by volume nitrogen to form the carbon supported catalyst.

By elementary analysis, a niobium content of 0.96% by weight, a titanium content of 4.8% by weight and a platinum content of 28% by weight, referring to the carbon supported catalyst, was determined.

The carbon supported catalyst was further analyzed by powder X-ray diffractometry. The average crystallite size of the platinum comprised in the carbon supported catalyst was calculated from the powder X-ray diffractometry results applying the Scherrer formula. A bimodal distribution of 3.1 nm and 29 nm was determined for the platinum crystallite size. Further, a crystallographic phase of TiO₂ (anatase) was observed in the carbon supported catalyst by powder X-ray diffractometry.

### COMPARATIVE EXAMPLES

### Comparative Example 1

### C1a) Deposition of Platinum onto Unmodified Carbon

20 g of Black Pearls® 2000 were suspended in 550 mL water by means of an ULTRA-TURRAX®. Then, a solution of 14.6 g platinum(II)nitrate in 215 mL water was added. Under stirring, a mixture of 471 mL ethanol and 650 mL water were added to the suspension and the suspension was heated to 82° C. After six hours at 82° C., the suspension was cooled to room temperature, filtered and the solid residue was washed with 6 L water. The resulting solid was dried in a vacuum oven at 80° C.

By elementary analysis, a platinum content of 28.1% by weight, referring to the produced catalyst from comparative example 1, was determined. The resulting catalyst was analyzed by X-ray diffractometry and applying the Scherrer formula the average platinum crystallite size was calculated. A bimodal distribution of 1.8 and 6.5 nm was obtained.

### Comparative Example 2

### C2a) Precipitation of Niobium Oxide onto Carbon

A mixture was prepared from 120 g carbon (Black Pearls® 2000, Cabot), 1090 g acetic acid with a purity of 100%, 1217 g 2-propanol with a purity of 99.7%, 104.9 g niobium(V)ethoxide with a purity of 99.95%, based on the metal content. In order to homogenize the components ultra-sonication was applied for 10 minutes. The mixture was dried in a spray-dryer. In order to prevent sedimentation, the mixture was agitated while being conveyed into the spray tower. The flow rate of the mixture to be spray-dried was 700 g/h. The diameter of the nozzle of the spray-dryer was 2.3 mm, the nozzle pressure was 3.5 bar absolute, the nozzle gas was nitrogen, the volume flow of the nozzle gas was 3.5 Nm³/h, the temperature of the nozzle gas was room temperature, the drying gas was nitrogen, the volume flow of the drying gas was 25 Nm³/h, the temperature of the drying gas was 190° C. and the residence time in the spray-dryer was 15 seconds. For particle separation, a cyclone was applied, which is able to separate particles with a diameter of at least 10 μm. The temperature in the cyclone, corresponding to the exhaust gas temperature of the spray-dryer, was 101° C. to 103° C. All above-described production steps were carried out with exclusion of humidity. No extra water was added in any of the above-described production steps and the mixture to be spray-dried was prepared under nitrogen atmosphere.

By elementary analysis, a niobium content of 10.6% by weight, referring to the spray-dried solid, was observed. During drying in an air stream of 180° C. for analytic purposes, a mass loss of 24.0% by weight was determined.

### C2b) Deposition of Platinum

20 g of the solid obtained in step C2a) were suspended in 444 mL water by means of an ULTRA-TURRAX®. Then, a solution of 11.98 g platinum(II)nitrate in 174 mL water was added. Under stirring, a mixture of 380 mL ethanol and 524 mL water was added and the suspension was heated to 82° C. After 6 hours at 82° C., the suspension was cooled to room temperature, filtered and the solid residue was washed with 6 L water. The resulting solid was dried in a vacuum oven at 80° C.

### C2c) Heat Treatment at 800° C.

The solid resulting from step C2b) was heat treated in 3 portions, which comprised 9.1 g, 10.4 g and 10.5 g, respectively. The heat treatment was carried out in a rotary tube furnace. In a stream comprising 95% by volume of nitrogen and 5% by volume of hydrogen, the temperature was raised by 10 Kelvin per minute to 800° C. When a temperature of 800° C. was reached, the temperature was kept constant for one hour. Subsequently, the interior of the furnace was cooled to room temperature and at a temperature below 50° C., the gas stream was switched to a stream comprising 100% by volume of nitrogen. Then, the heat treated solid was passivated for 12 hours with a gas stream comprising 9% by volume of air and 91% by volume of nitrogen to form the carbon supported catalyst. The three portions of this solid were mixed with a spatula and in all subsequent steps this mixture of the portions was used.

By elementary analysis, a niobium content of 9.6% by weight and a platinum content of 33% by weight, referring to the carbon supported catalyst, were determined.

The carbon supported catalyst was analyzed by powder X-ray diffractometry and the average platinum crystallite size was calculated applying the Scherrer formula. A bimodal distribution of 3 and 22 nm was obtained.

### Comparative Example 3

### C3a) Precipitation of Niobium Oxide onto Carbon Having a Low Specific Surface Area

A mixture was prepared from 120 g carbon (Vulcan XC72®, Cabot), possessing a specific BET surface of approximately 250 m²/g, 1099 g acetic acid with a purity of 100%, 1217 g 2-propanol with a purity of 99.7% and 209.8 g niobium(V)ethoxide with a purity of 99.95%, based on the metal content. In order to homogenize the components ultra-sonication was applied for 10 minutes. A mixture of 178 g water and 178 g 2-propanol was added dropwise. The mixture was dried in a spray-dryer. In order to prevent sedimentation, the mixture was agitated while being conveyed into the spray-tower. The flow rate of the mixture to be spray-dryer was 521 g/h, the diameter of the nozzle of the spray-dryer was 2.3 mm, the nozzle pressure was 3.0 bar absolute, the nozzle gas was nitrogen, the volume flow of the nozzle gas was 3.5 Nm³/h, the temperature of the nozzle gas was room temperature, the drying gas was nitrogen, the volume flow of the drying gas was 25 Nm³/h, the temperature of the drying gas was 190° C. and the residence time in the spray-dryer was 15 seconds. For particle separation, a cyclone was applied, which was able to separate particles with a diameter of at least 10 μm. The temperature in the cyclone corresponding to the exhaust temperature of the spray-dryer was 104° C. to 107° C.

By elementary analysis a niobium content of 13.5% by weight was determined, referring to the spray-dried solid. During drying in an air stream at 180° C. for analytic purposes, a mass loss of 12.8% by weight was determined.

### C3b) Deposition of Platinum

10 g of the solid obtained in step C3a) were suspended in 229 mL water by means of an ULTRA-TURRAX®. Then, a solution of 6.18 g platinum(II)nitrate in 89 mL water was added. Under stirring, a mixture of 196 mL ethanol and 270 mL water was added and the suspension was heated to 82° C. After 6 hours at 82° C., the suspension was cooled to room temperature, filtered and the solid residue was washed with 4 L water. The resulting solid was dried in a vacuum oven at 80° C.

### C3c) Heat Treatment at 800° C.

12.7 g of the solid resulting from step C3b) were heat treated in a rotary tube furnace. In a stream comprising nitrogen the temperature was raised by 10 Kelvin per minute to 400° C. After the temperature of 400° C. was reached, the gas stream was switched to a stream comprising 95% by volume of nitrogen and 5% by volume of hydrogen. The temperature was raised by 10 Kelvin per minute to 800° C. When the temperature of 800° C. was reached, the temperature was kept constant for one hour. Subsequently, the interior of the furnace was cooled to room temperature and at a temperature below 50° C., the gas stream was switched to a gas stream comprising 100% by volume of nitrogen. Then, the heat treated solid was passivated for 12 hours with a gas stream comprising 9% by volume air and 91% by volume nitrogen to form the carbon supported catalyst.

By elementary analysis, a niobium content of 13.5% by weight and a platinum content of 28.5% by weight, referring to the carbon supported catalyst, were determined. Further, a crystallographic phase of Nb₂O₅ and NbO₂, respectively, was observed in the carbon supported catalyst by powder X-ray diffractometry.

### II. Electrochemical Testing of Carbon Supported Catalysts

The carbon supported catalysts resulting from example 1 and comparative examples 1, 2 and 3 were tested in the oxygen reduction reaction (ORR) on a rotating disk electrode (RDE) at room temperature. The setup comprised three electrodes. As counter electrode a platinum foil and as reference electrode an Hg/HgSO₄ electrode were installed. The noted potentials refer to a reversible hydrogen electrode (RHE). An ink, comprising the carbon supported catalyst, was prepared by dispersing approximately 0.01 g carbon supported catalyst in a solution, consisting of 4.7 g demineralized ultra-pure water with a conductivity of less than 0.055 μS/cm, 0.04 g of a solution of 5% by weight of Nafion®, which is a perfluorinated resin solution, commercially available from Sigma-Aldrich Corp., comprising 80% to 85% by weight of lower aliphatic alcohols and 20% to 25% by weight of water, and 1.2 g of 2-propanol. The ink was treated by ultra-sonication for 15 minutes.

7.5 μL of the ink were pipetted on a glassy carbon electrode with a diameter of 5 mm. The ink was dried without rotation of the electrode in a flow of nitrogen. As electrolyte a 0.1 M solution of HClO₄ was applied, which was saturated with argon.

Initially, cleaning cycles and cyclovoltamograms for background subtraction (Ar-CV) were applied. These steps are further defined as steps 1 and 2 in table 1.

Subsequently, the electrolyte was saturated with oxygen and the oxygen reduction activity was determined (step 3, table 1).

Thereafter, an accelerated degradation test was applied in argon-saturated electrolyte. Therefore, the potential was changed according to square wave cycles (step 5, table 1).

Subsequently, the electrolyte was exchanged against a fresh 0.1 M HClO₄ solution and the steps of cleaning and Ar-CV in argon-saturated electrolyte were repeated (steps 6 and 7 in table 1) and the oxygen reduction (ORR) activity was measured again in oxygen saturated electrolyte (step 8 in table 1).

TABLE 1
Examination steps

| | | Saturation | Rotation | No of | | Scan rate or |
|---|---|---|---|---|---|---|
| Step No. | Type | gas | rate | cycles | Potential range | hold time |
| 1 | Cleaning | Argon | 0 rpm | 5 | 50-1400 mV | 1000 mV/s |
| 2 | Ar-CV | Argon | 0 rpm | 3 | 10-1000 mV | 20 mV/s |
| 3 | ORR-CV | Oxygen | 1600 rpm | 3 | 10-1000 mV | 20 mV/s |
| 4 | Ar-CV | Argon | 0 rpm | 3 | 10-1000 mV | 20 mV/s |
| 5 | Degradation | Argon | 0 rpm | 20,000 | 100-1000 mV | 0.5 s/0.5 s |
| 6 | Cleaning | Argon | 0 rpm | 5 | 50-1400 mV | 1000 mV/s |
| 7 | Ar-CV | Argon | 0 rpm | 3 | 10-1000 mV | 20 mV/s |
| 8 | ORR-CV | Oxygen | 1600 rpm | 3 | 10-1000 mV | 20 mV/s |

The electrochemical performance of the different carbon supported catalysts is expressed by the comparison between the ORR activities before (step 3) and after (step 8) the degradation tests (step 5).

From the anodic part of the third ORR-CV the Ar-CV from the prior step was subtracted, in order to remove the background currents. The platinum-mass-related kinetic activity lₖᵢₙ was calculated by taking into account the current at 0.9 V (l_{0.9V}) the limiting current at approximately 0.25 V (lₗᵢₘ) and the mass of platinum on the electrode (m_{Pt}):

lₖᵢₙ=l_{0.9V}·lₗᵢₘ/(lₗᵢₘ−l_{0.9V})m_{Pt}

The assumptions made for this calculation method and further details thereof are described in Paulus et al., in Journal of Electroanalytical Chemistry, 495 (2001), pages 134 to 145.

TABLE 2
Stability of the carbon supported catalysts

ORR activity/mA/mg_{Pt}

| | fresh catalyst | after degradation |
|---|---|---|
| | (step 3) | (step 8) |
| Example 1 | 315 | 287 |
| Example 2 | 296 | 284 |
| Example 3 | 277 | 275 |
| Example 4 | 407 | 354 |
| Comparative Example 1 | 321 | 219 |
| Comparative Example 2 | 232 | 235 |
| Comparative Example 3 | 121 | 124 |

The amount of platinum required for a certain performance in applications for example in fuel cells strongly depends on the stability of the carbon supported catalyst as well as on the initial activity of the fresh carbon supported catalyst. The residual activity of the used carbon supported catalyst after degradation test is a crucial parameter, mimicking the degradation of the catalytically active metal phase in a real fuel cell to a large extent.

The catalyst according to the invention being modified with the oxide comprising niobium and titanium and prepared in example 1 showed with 287 mA/mg_{Pt} the highest residual activity after degradation over all examples and comparative examples. All inventive catalysts of examples 1, 2 and 3 showed a higher stability against electrochemical degradation with higher residual activities after degradation in comparison with catalysts without modifier or with catalysts comprising only niobium oxide as modifier instead of an oxide comprising both niobium and titanium.

The concentration of the oxidic modifier comprised in the carbon supported catalysts resulting from example 1 and comparative example 2 was similar. Hence, the higher residual activity for the inventive carbon supported catalyst resulting from example 1 can be attributed to the modification of the carbon support with an oxide comprising both niobium and titanium.

Still, the niobium-oxide-modified catalyst resulting from comparative example 2 showed a higher residual activity after the degradation test than the catalyst without any modifier resulting from comparative example 1.

The catalyst resulting from comparative example 3, which was modified with niobium oxide and which comprised a carbon-comprising support with a low surface area showed clearly the lowest residual activity over all example and comparative examples, even though the content of niobium oxide and platinum in the carbon supported catalysts were similar.

1.-20. (canceled)

21. A carbon supported catalyst comprising
a carbon-comprising support with a BET surface area in a range from 400 m²/g to 2000 m²/g,
a modifier comprising:
at least one mixed metal oxide, comprising niobium and titanium;
a mixture comprising niobium oxide and titanium oxide; or
at least one mixed metal oxide comprising niobium and titanium and a mixture comprising niobium oxide and titanium oxide;
a catalytically active metal compound, wherein the catalytically active metal compound is platinum or an alloy comprising platinum and a second metal or an intermetallic compound comprising platinum and a second metal, the second metal being selected from the group consisting of cobalt, nickel, chromium, copper, palladium, gold, ruthenium, scandium, yttrium, lanthanum, niobium, iron, vanadium and titanium,
wherein the carbon supported catalyst comprises 0.5% to 20% by weight of niobium and 0.5% to 10% by weight of titanium.

22. The carbon supported catalyst according to claim 21, wherein the ratio of the molar amount of niobium comprised in the carbon supported catalyst to the sum of the molar amount of niobium and the molar amount of titanium comprised in the carbon supported catalyst is in a range from 0.01 to 0.5.

23. The carbon supported catalyst according to claim 21, wherein the carbon supported catalyst comprises 10% to 50% by weight of platinum.

24. The carbon supported catalyst according to claim 21, wherein the catalytically active metal compound is present in form of nanoparticles.

25. The carbon supported catalyst according to claim 21, wherein the modifier consists of niobium, titanium and oxygen.

26. The carbon supported catalyst according to claim 21, wherein all metal comprised in the carbon supported catalyst is comprised in the modifier and in the catalytically active metal compound.

27. The carbon supported catalyst according to claim 21, wherein the carbon-comprising support comprises carbon black, graphene, graphite, activated carbon or carbon nanotubes.

28. An electrode comprising the carbon supported catalyst according to claim 21.

29. A fuel cell comprising the electrode according to claim 28.

30. A process for preparing the carbon supported catalyst according to claim 21, comprising the following steps:
(a) precipitating the modifier onto the surface of the carbon-comprising support by preparing an initial mixture, comprising the carbon-comprising support with a BET surface area in a range from 400 m²/g to 2000 m²/g, at least two metal oxide precursors, a first precursor comprising niobium and a second precursor comprising titanium, and a solvent, and drying of the initial mixture to obtain an intermediate product, or heating the initial mixture to a temperature at which the initial mixture is boiling, followed by filtration,
(b) loading of the catalytically active metal compound in form of particles onto the surface of the intermediate product in a liquid medium by deposition, precipitation and/or reduction of a catalytically active-metal-comprising precursor with a reducing agent,
(c) heat treatment of the catalyst precursor resulting from step (b) at a temperature of at least 200° C. in a reducing atmosphere.

31. The process according to claim 30, wherein the initial mixture comprises an acid.

32. The process according to claim 31, wherein the acid is a carboxylic acid.

33. The process according to claim 30, wherein the drying in step (a) is carried out as spray-drying.

34. The process according to claim 30, wherein the drying is carried out with an inert drying gas.

35. The process according to claim 30, wherein at least one of the metal oxide precursors is an alcoholate selected from the group consisting of ethanolate, n-propanolate, iso-propanolate, n-butanolate, iso-butanolate and tert-butanolate, or at least one of the metal oxide precursors is a chloride.

36. The process according to claim 30, wherein the solvent is an alcohol, a carboxylate ester, acetone or tetrahydrofuran.

37. The process according to claim 30, wherein after filtration the intermediate product is washed with a washing liquid comprising a solvent.

38. The process according to claim 37, wherein the solvent used for washing is the same solvent as in the initial mixture.

39. The process according to claim 37, wherein the washing liquid additionally comprises an acid, preferably a carboxylic acid.

40. The process according to any of claim 30, wherein a washing step using water as washing liquid is carried out before carrying out step (b).
